(19) United States
(12) Patent Application Publication
(10) Pub. No.: US 2022/0184596 A1
(43) Pub. Date: Jun. 16, 2022

(54) ORGANIC SOLVENT TREATMENT METHOD

(71) Applicant: KURITA WATER INDUSTRIES LTD., Tokyo (JP)

(72) Inventors: Yu FUJIMURA, Tokyo (JP); Takahiro KAWAKATSU, Tokyo (JP); Yoichi TANAKA, Tokyo (JP)

(73) Assignee: KURITA WATER INDUSTRIES LTD., Tokyo (JP)

(21) Appl. No.: 17/442,573

(22) PCT Filed: Mar. 10, 2020
(86) PCT No.: PCT/JP2020/010212

§ 371 Date: Sep. 23, 2021

(30) Foreign Application Priority Data
Mar. 27, 2019 (JP) 2019-060899

(51) Int. Cl. B01J 47/014; B01J 41/14; B01J 41/13; B01J 47/127; B01D 15/36

(52) U.S. Cl. CPC B01J 47/014; B01J 41/14; B01D 15/363; B01J 47/127; B01J 41/13

(57) ABSTRACT

An organic solvent treatment method for removing particulates from an organic solvent used in a manufacturing step of electronic components is characterized by comprising a step of bringing the organic solvent into contact with a treatment material that has a positive or negative electric charge in water and has a moisture content of 3% by mass or more. An organic solvent treatment material, which is to be used in the manufacturing step of electronic components and which is for removing particulates from an organic solvent by coming into contact with the organic solvent used in the manufacturing step of electronic components, has a positive or negative electric charge in water.

### BACKGROUND

### Technical Field

The present invention relates to a treatment method and a treatment material for removing particulates from an organic solvent used in a manufacturing step of electronic components.

### Related Art

In recent years, due to the development of a semiconductor manufacturing process, a control of particulates in water has become more and more strict. For example, according to International Technology Roadmap for Semiconductors (ITRS), a guaranteed value of particle diameter >11.9 nm is required to be <1000 particles/L in 2019. In relation to this, there is no clear particulate control set for the removal of particulates in a solvent used in semiconductor manufacturing as in the case of the above ultrapure water. However, with the miniaturization of a semiconductor structure, a solvent with a low surface tension has come to be used during wafer cleaning in order to prevent pattern collapse. As a result, there is an increasing need for removing particulates and the like in a solvent.

A distillation method has been conventionally performed as a method for removing particulates from an organic solvent (Patent literatures 1 and 2). In addition, filtering of an organic solvent is also performed with a filter (Patent literature 3).

Patent literature 4 describes not only distillation but also contact with an ion exchange resin (cationic resin, anionic resin, or a mixture thereof) in order to remove particulates from isopropyl alcohol.

Moreover, Patent literature 5 describes that an anion adsorption membrane having an anion exchange group is brought into contact with water in order to reduce a concentration of silica in ultrapure water.

Patent literature 1: Japanese Patent Laid-Open No. 58-211000

Patent literature 2: Japanese Patent Laid-Open No. 2016-30233

Patent literature 3: Japanese Patent Laid-Open No. 2-119901

Patent literature 4: Japanese Patent Laid-Open No. 2003-535836

Patent literature 5: Japanese Patent Laid-Open No. 10-216721

### SUMMARY

A purpose of the present invention is to provide an organic solvent treatment method and a treatment material capable of removing particulates from an organic solvent used in a manufacturing step of electronic components.

### Means to Solve Problems

A treatment method for an organic solvent used in a manufacturing step of electronic components of the present invention includes a step of bringing the organic solvent into contact with a treatment material that has a positive or negative electric charge in water and has a moisture content of 3% by mass or more.

In one aspect of the present invention, ultrapure water is added to the organic solvent before the contact step.

In one aspect of the present invention, a treatment material that has been contact-treated with water is used as the treatment material.

In one aspect of the present invention, the treatment material includes a polymer having an anion exchange group.

In one aspect of the present invention, the treatment material is in the form of fibers.

A treatment material of the present invention is an organic solvent treatment material for removing particulates from an organic solvent by coming into contact with the organic solvent used in a manufacturing step of electronic components, and has a positive or negative electric charge in water.

### Effect

According to the treatment method and the treatment material of the present invention, the particulates in the organic solvent can be adsorbed on the treatment material and removed.

### DESCRIPTION OF THE EMBODIMENTS

Hereinafter, the present invention is further described in detail.

In a method of the present invention, an organic solvent used in a manufacturing step of electronic components is brought into contact with a treatment material having a positive or negative electric charge in water and having a moisture content of 3% by mass or more in a liquid state to remove particulates. The particulates may be, in addition to silica particulates, various inorganic or organic particulates, particularly particulates having a positive or negative electric charge.

In one aspect of the present invention, a material that has been brought into contact with water before being brought into contact with the organic solvent is used as the treatment material.

In another aspect of the present invention, the treatment material is brought into contact with an organic solvent to which ultrapure water has been added.

The treatment material preferably includes a polymer to which a cation exchange group or an anion exchange group is applied.

As the polymer, the following raw materials can be used. There are polyolefin such as polyethylene, polypropylene, and the like, polyether such as polyethylene oxide, polypropylene oxide, and the like, fluororesin such as PTFE, CTFE, PFA, polyvinylidene fluoride (PVDF), and the like, halogenated polyolefin such as polyvinylchloride and the like, polyamide such as nylon-6, nylon-66, and the like, urea resin, phenolic resin, melamine resin, polystyrene, cellulose, cellulose acetate, cellulose nitrate, polyether ketone, polyether ketone ketone, polyether ether ketone, polysulfone, polyether sulfone, polyimide, polyether imide, polyamide imide, polybenzimidazole, polycarbonate, polyethylene terephthalate, polybutylene terephthalate, polyphenylene sulfide, polyacrylonitrile, polyether nitrile, polyvinyl alcohol, copolymers thereof, and the like. However, the polymer is not limited thereto. The polymer is not particularly limited to one type of raw material, and various raw materials can be selected as necessary. However, the raw material is required to have resistance to the organic solvent.

When ion exchange capacity is applied to the polymer, the ion exchange group may be a sulfonic acid group, an orthophosphoric acid group, a phosphonic acid group, a phosphinic acid group, a carboxylic acid group, a hydroxyl group, a phenol group, a quaternary ammonium group, a primary to tertiary amine group, a pyridine group, an amide group, and the like, and the ion exchange group is not limited thereto. These functional groups may be not only an H-type and an OH-type, but also a salt-type such as Na or the like. In the present invention, a thread in which at least one or more types of these functional groups is introduced may be used, or a plurality of types of threads in which different ion exchange groups are respectively introduced may be used to form a composite filter having different exchange groups.

An introducing method for the functional group differs depending on the quality of material of the polymer, and an appropriate introducing method is selected. For example, when the polymer is polystyrene, the sulfonic acid group can be introduced by adding an appropriate amount of paraformaldehyde to a sulfuric acid solution and performing heat-crosslink. When the polymer is polyvinyl alcohol, the functional group can be introduced by causing a trialkoxysilane group, a trichlorosilane group, an epoxy group, or the like to act on the hydroxyl group, or the like. When the functional group cannot be directly introduced depending on the quality of material, a desired functional group may be introduced through an introducing operation having two or more stages, such as first introducing highly reactive monomers (referred to as reactive monomers) such as styrene and the like, and then introducing the functional group. The reactive monomers may be glycidyl methacrylate, styrene, chloromethylstyrene, acrolein, vinylpyridine, acrylonitrile, and the like, and the reactive monomers are not limited thereto. The functional group may be introduced before nanofibers are formed, or when fibers are focused, the ion exchange group may be introduced by coating or kneading polymers or resins having ion exchange capacity that have been dissolved or finely pulverized, or bonding the above polymers or resins by a chemical reaction.

In addition to a flat membrane, the form of the treatment material may be any of a fiber shape, a hollow fiber shape, and the like. The treatment material may be a porous membrane.

By contacting the treatment material with water before contacting the treatment material with the organic solvent, a particulate removing performance of the treatment material can be improved. A treatment of contacting the treatment material with water (ultrapure water) in this way is preferably performed when the organic solvent to be treated is 100% organic solvent to which ultrapure water is not added. Moreover, in the present invention, a treatment in which a treatment material is brought into contact with the ultrapure water and then the treatment material is brought into contact with an organic solvent to be treated may be hereinafter referred to as a water contact treatment.

In order to perform the water contact treatment, for example, the treatment material and the ultrapure water are housed in a container and brought into contact with each other, then the organic solvent to be treated is injected into the container, and thereafter the organic solvent is discharged. In addition, the organic solvent to be treated may be distributed after the treatment material is filled into a column and the ultrapure water is distributed. In the latter case, the organic solvent may be made to continue to flow as it is and shift to an organic solvent treatment step.

The method of contacting the treatment material with the organic solvent or an organic solvent to which ultrapure water has been added (hereinafter, may be referred to as an organic solvent and the like) includes, in addition to a method of putting the treatment material into the container in which the organic solvent and the like are housed and immersing the treatment material, a method of passing the organic solvent and the like through the column in which the treatment material is housed, a method in which when the treatment material is a porous membrane, contact is made in a form that the organic solvent and the like are permeated through the porous membrane, and other methods, and the method is not limited thereto.

The organic solvent which is used in the manufacturing step of electronic components and to be treated in the present invention is not particularly limited, and typical examples thereof are mentioned as follows. That is, the typical examples include: alcohols such as methanol, ethanol, isopropyl alcohol, and the like; halogenated hydrocarbons such as methylene chloride, chloroform, carbon tetrachloride, trichloroethylene, perchloroethylene, 1,1,1-trichloroethane, chlorofluorocarbon 113, chlorobenzene, o-, m-, p-dichlorobenzen, o-, m-, p-dichlorobenzen, o-, m-, p-chlorotoluene, and the like; ethers such as ethyl ether and the like; epoxies such as PO, BO, and the like; hydrocarbons such as hexane, cyclohexane, benzene, toluene, xylene, and the like; ketones such as acetone, MEK, MIBK, and the like; esters such as ethyl acetate, n-propyl, iso-propyl, n-butyl, sec-butyl, tert-butyl, and the like; and N-methyl-2-pyrrolidone (NMP).

The present invention is particularly suitable for treating an organic solvent used in a semiconductor manufacturing process, such as isopropyl alcohol (hereinafter, may referred to as IPA), N-methyl-2-pyrrolidone (NMP), or the like.

When the organic solvent containing ultrapure water is brought into contact with the treatment material to remove the particulates in the organic solvent, the ultrapure water is preferably added in an amount of 5% to 80% by mass, and particularly 5% to 50% by mass with respect to the total solvent (a total of the organic solvent and the ultrapure water), but the amount of the added ultrapure water is not limited thereto.

### EXAMPLE

Hereinafter, examples and comparative examples are described.

In Examples 1 to 4 and Comparative example 1 below, the following IPA-based test solutions and the following treatment materials were brought into contact with each other by Contact method 1 below.

### <Test Solution>

Test solution 1: a solution obtained by adding 50 mg/L of silica particulates (sicastar manufactured by Corefront Co., Ltd.: particle diameter of 30 nm) to IPA (high-purity IPA manufactured by Kanto Chemical Co., Inc.)

Test solution 2: a solution obtained by mixing the IPA and the ultrapure water at a ratio of 50:50 and adding the silica particulates in the above amount

### <Treatment Material>

Treatment material A: ion exchange fiber DMAEMA fiber manufactured by Environment Purification Research Institute. Inc., 20 m (7.7 g) Treatment material B: anion exchange membrane AHA manufactured by Astom Co., Ltd., about 30 cm×20 cm, 220 μm thick (16 g in a wet state)

### <Contact Method>

The treatment material was filled into a polyethylene container (volume: 250 mL), and 100 mL of the test solution was injected to immerse the treatment material for 30 minutes.

### Examples 1 to 4, Comparative Examples 1 and 2

The above Test solution 1 or 2 was brought into contact with each of treatment materials treated as described below according to the above Contact method 1. A concentration of silica after the contact was measured by molybdenum absorption spectrophotometry, and a silica removal rate was calculated. The results are shown in Table 1.

Example 1: the above Treatment material A (used as it is without being treated)

Example 2: the above Treatment material B (used as it is without being treated)

Example 3: a water-contacted product obtained in a manner that Treatment material B and 100 mL of the ultrapure water were housed in the polyethylene container (volume: 250 mL), immersed for 30 minutes, and then the ultrapure water was discharged.

Example 4: the above Treatment material A (used as it is without being treated)

Comparative example 1: a dried product obtained by drying Treatment material A at 110° C. for 24 hours

Comparative example 2: a dried product obtained by drying Treatment material B at 110° C. for 24 hours

TABLE 1

| | | Moisture | | |
|---|---|---|---|---|
| | | content of | | Silica |
| | | treatment | | removal |
| No. | Treatment material | material | Test solution | rate |
| Example 1 | Treatment material A (as it is) | 3% | Test solution 1 (only IPA) | 65.67% |
| Example 2 | Treatment material B (as it is) | 20% | Test solution 1 (only IPA) | 35.57% |
| Example 3 | Treatment material B | 37% | Test solution 1 (only IPA) | 98.43% |
| | (water-contacted product) | | | |
| Example 4 | Treatment material A (as it is) | 3% | Test solution 2 (IPA + | 86.39% |
| | | | ultrapure water) | |
| Comparative | Treatment material A (dried | 0%* | Test solution 2 (IPA + | 3.92% |
| example 1 | product) | | ultrapure water) | |
| Comparative | Treatment material B (dried | 0%* | Test solution 2 (IPA + | 1.12% |
| example 2 | product) | | ultrapure water) | |

*Calculation method of moisture content
Moisture content = [1 - (weight of treatment material after drying treatment/weight of treatment
material before drying treatment)] • 100 (%)

[Consideration]

In Examples 1 and 2 performed in a conditioning state in which the moisture content is 3% by mass or more, a silica removal rate better than that of Comparative examples 1 and 2 can be obtained.

Furthermore, when the moisture content of the treatment material is further increased

(Example 3), a higher silica removal rate can be obtained.

In addition, by adding the ultrapure water to the IPA, a quite good silica removal rate can be obtained even if Treatment material A is not water-conditioned.

### Reference Examples 1 to 3

The above Treatment materials A and B were brought into contact with ultrapure water containing silica particulates (the addition amount of the silica particulates: 50 μg/L) according to Contact method 1 to obtain a silica removal rate.

The results are shown in Table 2.

TABLE 2
(Test solution: ultrapure water containing silica particulates)

| No. | Treatment material | Silica removal rate (%) |
|---|---|---|
| Reference example | Treatment material A | 99 |
| 1 | (as it is) | |
| Reference example | Treatment material B | 78 |
| 2 | (as it is) | |

Although the present invention has been described in detail using specific aspects, it is apparent to those skilled in the art that various modifications can be made without departing from the intention and scope of the present invention.

This application is based on Japanese Patent Application 2019-060899 filed on Mar. 27, 2019, and is supported in the entirety thereof by reference.

1. An organic solvent treatment method, for removing particulates from an organic solvent used in a manufacturing step of electronic components, comprising:
a step of adding ultrapure water into the organic solvent in an amount of 5% to 80% by mass (excluding 5% to 15% by mass) with respect to a total of the organic solvent and the ultrapure water,
a step of bringing the organic solvent containing ultrapure water into contact with a treatment material that has a positive or negative electric charge in water and has a moisture content of 3% by mass or more,
the treatment material comprises a polymer having an anion exchange group.

2. (canceled)

3. The organic solvent treatment method according to claim 1, wherein a treatment material that has been contact-treated with water is used as the treatment material.

4. (canceled)

5. (canceled)

6. The organic solvent treatment method according to claim 1, wherein the treatment material is in the form of fibers.

7. (canceled)

8. (canceled)

9. The organic solvent treatment method according to claim 3, wherein the treatment material is in the form of fibers.
